(19) United States
(12) Patent Application Publication
(10) Pub. No.: US 2024/0317230 A1
(43) Pub. Date: Sep. 26, 2024

(54) Smart Regenerative Braking for Electric Vehicles

(71) Applicants: Scott C Harris, San Diego, Ca (US); Benjamin J Kwitek, Colorado Springs, Co (US)

(72) Inventors: Scott C Harris, San Diego, Ca (US); Benjamin J Kwitek, Colorado Springs, Co (US)

(21) Appl. No.: 18/187,178

(22) Filed: Mar. 21, 2023

(51) Int. Cl. B60W 30/18; B60L 7/10

(52) U.S. Cl. CPC B60W 30/18127; B60L 7/10; B60W 2520/04; B60W 2552/15; B60W 2555/20; B60W 2710/18

(57) ABSTRACT

A vehicle, having a battery, that is charged by regenerative braking. The system detects a condition which indicates that the current context of the vehicle, such as location of the vehicle, erratic operation of the vehicle, geography around the vehicle, driving conditions around the vehicle/and or information from others about a current location, is one in which regenerative braking could interfere with driving and operating to modify the regenerative braking responsive to detecting the condition.

### BACKGROUND

Electric vehicles (EVs) are becoming more popular around the world for many reasons. These include their zero emissions that help air quality, lower maintenance costs, increased performance—especially in urban environments, and social appeal. In this application, vehicles may refer to automobiles, trucks, SUVs, vans, tractors, carts, ATVs, motorcycles, and all other powered machines that transport one or more people or items.

Internal combustion engine vehicles have conventionally utilized an accelerator (or gas pedal) to manage the acceleration. Simply put, more pressure on the accelerator provides more fuel to the engine which in turn produces more power. This process of producing horsepower and torque has a brief delay due to the timing of the combustion within the engine. In addition to the accelerator, internal combustion vehicles have a brake pedal. The brake pedal is connected to hydraulic fluid that exerts pressure on the rotors at each wheel by pushing pads into them. This effectively scrubs speed from the spinning rotors and releases that energy into the air as heat. This is why sportscars often have advanced rotors with grooves or holes to control temperatures. The rotors can also be formed from enhanced materials such as carbon fiber. The acceleration and braking function of internal combustion engine vehicles are largely unrelated as they are separate systems.

Electric vehicles are operated by an electric motor or motors and can very quickly change their speed. This allows for near immediate power delivery to the wheels. Reducing pressure on the accelerator in an EV causes the motor(s) to slow immediately. This can allow the battery to be charged by the slowing of the vehicle by so called regenerative braking as the electric motors become electric generators. The brakes on an EV are similar to an internal combustion vehicle but they can also help charge the battery as they press on the rotors.

Regenerative braking allows for electric motor power reduction to charge the battery and slow the vehicle. In essence it acts like a brake on the vehicle. This is advantageous for at least two reasons. One, it helps charge the battery. This increases range and reduces the need to charge the EV's battery through either an AC connection or a DC fast charge connection. Two, it allows for “one pedal driving.” In other words, the modulation of the accelerator pedal can allow for “braking” without having to depress the brake pedal. This is convenient and it also reduces wear on the braking system in the vehicle. EV makers even have the brake lights of the vehicle illuminate to warn other drivers of the slowing speed even though the brake pedal was never touched. It is simply the electric motor(s) spinning down that is slowing the vehicle.

Regenerative braking has some negative effects as well. One, it can be somewhat difficult to get used to. It requires the driver to shed their well-established driving habits in favor of this new method. It sometimes leads to driving than is less smooth or jerky. Two, the effect of regenerative braking can be somewhat abrupt. New EV drivers often have complaining passengers as they are somewhat violently pulled forward as the vehicle slows. One-pedal driving is somewhat hard to manage. Some EV makers have adjustments to the amount of regenerative braking—from zero (feels more like a traditional internal combustion vehicle) to full regenerative (which can be one-pedal driving 100 percent of the time). Many drivers want to have some regenerative braking engaged as it saves them money, time recharging, wear on the brake components, and also helps the environment.

### SUMMARY OF THE INVENTION

The present invention utilizes advanced software, computing power and proprietary methods to increase the functionality and usability of electric vehicles and regenerative braking systems based on problems recognized by the inventors.

The inventors recognized that some situations make for difficult driving caused by difficult regenerative braking. In general, those situations can be caused by difficult location-based use cases where having the regenerative braking engaged makes for frustrating driving.

Embodiments describe situations and operations for addressing the difficult use cases of this type.

An embodiment describes a vehicle with a control system operating to normally carry out regenerative braking, and to detect a condition which indicates that the current context of the vehicle is one which regenerative braking could interfere with driving, and changes the regenerative braking during the time of that condition.

### BRIEF DESCRIPTION OF THE DRAWINGS

In the Drawings:

FIG. 1 shows a vehicle using the present system; and

FIG. 2 shows a flowchart of operation.

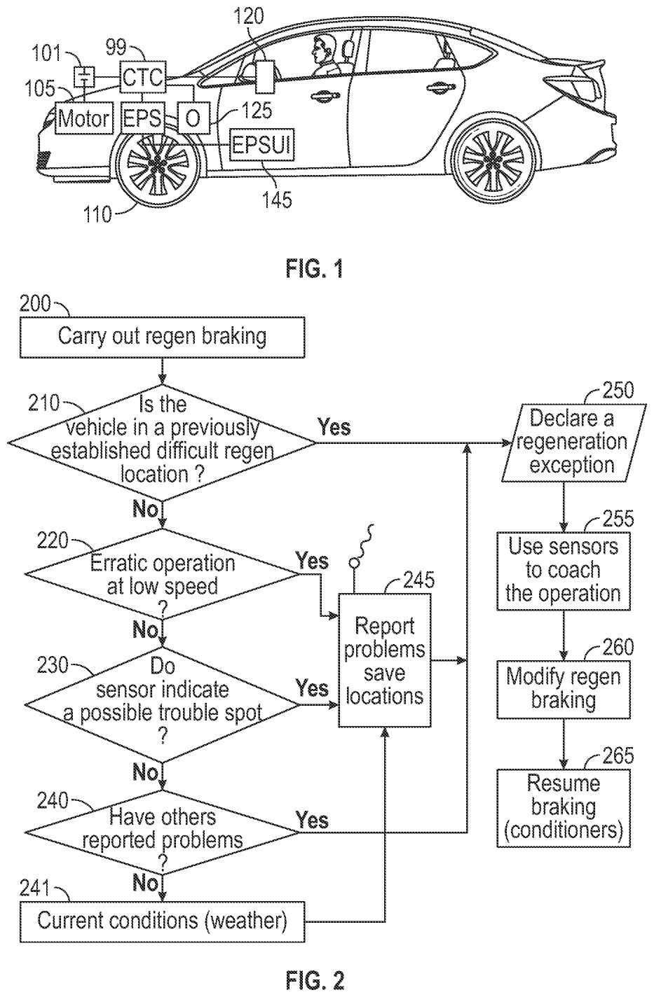

### DETAILED DESCRIPTION

Embodiments describe techniques to improve the use case operation which can otherwise be difficult when regenerative braking is engaged. Some of these operations are described with reference to examples of operation which are to be considered as embodiments herein.

In certain parking situations, such as when pulling into a tight garage, the inventors recognized that drivers often need to “creep” forward slowly so as to move the vehicle with precision into the desired parking space. This cannot be done quickly, out of fear that the vehicle could scrape on the side of the garage, hit another vehicle, or collide with other objects. This can be especially true with sloped driveways. Whether positive or negative in slope, this type of driveway necessitates additional caution as either more acceleration is required to climb the driveway, or deceleration or braking is needed to avoid moving too quickly.

The regenerative braking feature can interfere with the user's ability to maneuver in this scenario. The regenerative braking can stop or slow the vehicle prematurely during the parking operation. When entering a driveway and garage, the vehicle can be excessively slowed by the regenerative braking, thus requiring the driver to depress the accelerator to overcome the regenerative braking. This depression of the accelerator pedal, however, can result in a surge of significant power to the drive train, as it overcomes the regenerative braking, removes the regenerative braking, and at the same time, applies motive force to the drivetrain. Unfortunately, this is exactly the wrong time for power surges in the vehicle, especially if, as is often the case, a precision parking operation is being carried out.

The unintentional application of power at the wrong time can lead to damage to the vehicle, such as knocking mirrors off the vehicle or hitting another car in the garage. When the driver tries to carefully “nurse” the accelerator, the EV tends to either surge powerfully or stop abruptly. There is not a lot of “creeping” which is what is necessary in tight parking situations.

The inventors found that this problem often occurs in secondary use cases—still these cases often occur on a daily basis and pose challenges for EV drivers.

Embodiments describe addressing this challenge while increasing driver satisfaction.

An embodiment is shown in the figures. A vehicle 100 has an electric motor 105 which provides power to drive the wheels 110 of the vehicle. There can be one or more of these electric motors, for example there can be one electric motor attached to each of the wheels. A controller 99 controls the battery 101 to drive the motor 105 to drive the wheel, based on the user controls 120 in the vehicle, for example the accelerator and the brake. This can also be done automatically under autonomous control, for example when the controller 99 is an autonomous controller for a vehicle. When the controller 120 requests power, this provides power from the battery 101 to the motor 105, and drives the wheel. Conversely, when regenerative braking is in effect, the motor is set into regeneration mode, and uses the force from the wheels to provide electricity back to the battery 101, so-called regenerative braking.

The vehicle 100 also includes a number of different sensors such as 125, which sense characteristics around the vehicle, which can include radar and LIDAR, cameras, and other environmental sensing sensors. A location detecting device 140 is shown as a GPS, which as conventional detects the location of the vehicle. There is also a user interface 145 for the GPS, into which the user conventionally enters a destination. The user can also enter a home setting into that GPS, telling the GPS where to go when the user wants to go “home”.

In operation, the controller 99, which can be one or many different devices, spread throughout the vehicle, can control the regenerative braking mode, illustrated in the flowchart of FIG. 2 which illustrates how the system operates during regenerative braking. Regenerative braking is normally carried out at 200, where the controller 99 instructs the different systems in the vehicle to retrieve power from the wheels when the gas pedal 120 is released, and provide braking force to those wheels while at the same time creating electricity that is sent to the battery.

During normal operation, regenerative braking continues. However, during any number of different operations, the system can operate to modify the normal regenerative braking.

As described herein, the regenerative braking is modified when the context of the vehicle indicates that regenerative braking could interfere with the normal driving operation of the vehicle. The context can include any of the items described herein, including the location of the vehicle, an analysis of operation of the vehicle, the geographical location of the vehicle, and current conditions such as weather conditions around the vehicle.

FIG. 2 illustrates different operations which can occur that can interfere with the normal regenerative braking. At 210, the system determines whether the vehicle is in a previously-established difficult regeneration location. This difficult regeneration location can be previously established by the user, or by others, or by detection by the system itself. 210 indicates that the system is detecting being on one of those previously established locations.

In one embodiment, the user can indicate that a frequent parking location has become difficult to park in due to their regenerative braking. In one use case, the user may have a sloped driveway at home, and in that case, the established geographical location is their home, and by getting close to their home, this indicates the previously established difficult regeneration location. In one embodiment, the system remembers difficult maneuvering locations from previous attempts to park in this location.

Other ways of establishing this location are also described herein.

If the vehicle is detected to be in a previously established difficult regeneration location, then control passes to step 250, which declares a regeneration exception, and handles this regeneration exception as described herein in a way to make it easier to operate the vehicle during the time of the exception, but automatically returning to the regeneration mode after the conditions that caused the exception are over.

Once this is remembered, then subsequently coming back to that same location later causes the system to remember that it will have difficulty parking or maneuvering in this situation. After the regeneration exception is established, the user is assisted with carrying out the maneuver, while still allowing the regenerative braking to continue after the maneuver. For example, the regeneration exception at 250 can cause the vehicle to reduce the amount of regenerative braking or terminate the regenerative braking entirely, or enter a different mode of regenerative braking which works better in a hilly environment or in the other geographic location.

In one embodiment, the difficult maneuvering remembered at 210 is a steep driveway in a user's home. In other embodiments, this can be a steep driveway in a parking garage or in other locations.

Using this system, the vehicle can “remember” the location of your home, driveway and garage, and also other places where the regeneration makes the driving more difficult. It simply changes the regenerative brake setting as this location was encountered. This way the benefits of the regenerative braking could be enjoyed on the commute but not frustrate or endanger the drive at the last 1-100 meters of their journey.

At 220, the system detects erratic driver inputs at low speed. For example, the system can detect erratic accelerator and brake motions, and determine from that this is a difficult parking location after this has happened one or many times. The system can also pop up a message to the user such as are you in a difficult parking location? In an alternative embodiment, the system can make its own decision based on the operation occurring multiple times in the same location. In one embodiment, this can detect stop and go creeping operations which can indicate this issue.

Another embodiment, shown at 230, uses the sensors on the vehicle to indicate a possible trouble spot for regenerative operation. In one embodiment, this can be geographical constraints, such as sloped driveways near the desired parking In other embodiments, this can use pattern recognition of the location and some degree of artificial intelligence (AI).

240 establishes the regeneration location based on others having reported problems specifically at this location. The others can report problems either manually, or through the detection of repeated difficulties. This forms a database. The database is shown as 245, where once the problems are detected, they are stored in a database and the location is saved. This database can be shared with other vehicles which can also use that database to establish the regeneration exception. This database can combine time, location and third-party data for various locations and can establish the regeneration exception at 150 based on operations of others in either similar make automobiles or in different automobiles.

The database and/or certain items from the database can be shared over a network, so that each vehicle can store a database of context where regeneration exceptions are likely. This database can be included into, for example, the GPS information, so that the GPS automatically provides data that can be used to modify the regenerative braking. In this way, the controller accesses a database of information indicating the condition being one which regenerative braking could interfere with driving, and adds new information to the database when the current context of the vehicle is one which regenerative braking could interfere with driving, and shares the new information with other vehicles.

As one use case, a coffee take out drive-through often involves a lot of starting and stopping as the line of vehicles progresses. Basically, every vehicle maneuvers through the drive through in a similar fashion. This data from the brand's vehicles (related vehicles, for example) is shared. When a pattern is established of many vehicles having difficulty with their regenerative braking in a specific location, this pattern can be used to declare the regeneration exception at 250.

100 BMWs™ can travel through the Starbucks™ drive through each day. These cars could then communicate to other BMWs™ on the best practices for navigating the drive through. The data from other all vehicles—even non-branded ones—can also be crowd-sourced to provide more intelligence. This crowd sourced information can provide data which analyzes and sets proper EV regenerative braking intelligence and optimization.

Another embodiment, shown in 241, is when the current conditions, such as weather conditions, become unreasonably dangerous, for various reasons. During a weather emergency, such as during heavy snow or slick conditions, braking may become dangerous. It may be dangerous to cause too much deceleration using the regenerative braking, and in fact the driver, not the controller should be the one who sets the amount of braking during those difficult conditions. Accordingly, the current weather conditions which can be detected from either the sensors, or from a network-based operation, can be used to set the regeneration exception.

Once the regeneration exception has been established at 250, the vehicle can then use different hardware and software control in the vehicle to address this. At 250, the Vehicle uses its sensors 125 to help manage the regenerative braking feature. These sensors include ultrasound, radar, LIDAR and cameras which can be used to detect closeness of objects and obstructions, to reduce the amount of regenerated braking when these objects are too close, and also can be used when the vehicle is being maneuvered through challenging environments. Driver input can override factory vehicle settings or help “coach” the system to behave in a better manner. This input could be done via touchscreen, buttons, voice input or any other selection mechanism. It is anticipated that this alteration would not impact the programming of the regenerative braking outside of this case or event situation. This way the driver would not lose the benefits of regenerative braking in 95% of the driving but it would help make them a better driver in the 5% of situations where regenerative braking creates hazards or imperfect maneuvering.

At 260, the regenerative braking is modified during the pendency of the regeneration exception. The regeneration exception can cause the system, for example, to reduce the amount of regenerative braking or turn it off entirely.

In another embodiment, the operation 240 can also include a manual instruction. The driver can instruct the EV about which locations it should reduce or eliminate the regenerative braking feature. Case in point, a driver who uses the drive-thru at a Starbucks, for example, could tell the vehicle that the lane for this coffee shop is tight and often congested with other vehicles. This communication could occur through choice or selections on the dash, console or touchscreen. It could also be verbalized, and the vehicle would recognize the command.

These methods and systems for improving regenerative braking in vehicles would also be helpful with fully autonomous vehicles. These autonomous vehicles will also carry passengers and their safety and comfort will be paramount. Nevertheless, increasing range and reducing charging will continue to be essential. Therefore, regenerative braking will need to be employed by autonomous EVs as well. Helping them navigate the last 10 meters is very important.

In this light, 265 shows that the regenerative braking is automatically resumed when the condition is over. That is, when the condition that caused the regenerative braking to occur has come to an end, the regenerative braking is automatically reengaged, so that the user can get the maximum effect from the regenerative braking and the reduction in regenerative braking occurs during only the minimum amount of time.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

1. (canceled)

2. The system as in claim 3, wherein the regenerative braking is automatically resumed to unmodified regenerative braking after the vehicle is no longer in the location.

3. A vehicle system, comprising:
a vehicle, having a battery, and having a controller that controls systems of the vehicle, the controller controlling regenerative braking in the vehicle that receives energy from wheels of the vehicle and converts the energy into electricity which is used to charge the battery;
the controller operating to detect the vehicle being in a location which has been previously established, at a prior time, prior to a current time, as a location where regenerative braking has made the driving more difficult at the prior time; and
the controller operating to modify the regenerative braking at the current time from an unmodified regenerative braking to a modified regenerative braking, responsive to detecting the vehicle being in the location where regenerative braking has made the driving more difficult at the prior time.

4. The system as in claim 3, wherein the location where regenerative braking has made the driving more difficult at the prior time is detected by obtaining information about locations where regenerative braking has made the driving more difficult at the prior time where others, other than the vehicle, have reported that regenerative braking has made the driving more difficult.

5-7. (canceled)

8. The system as in claim 3, wherein the modified regenerative braking is modified by reducing an amount of regenerative braking while in the location where regenerative braking has made the driving more difficult at the prior time.

9. The system as in claim 3, where the modified regenerative braking is modified by terminating regenerative braking while in the location where regenerative braking has made the driving more difficult at the prior time.

10. The system as in claim 3, wherein the location of the vehicle where regenerative braking has made the driving more difficult, is shared with other vehicles.

11. The system as in claim 3, wherein the controller accesses a database of locations where regenerative braking has made the driving more difficult for others, other than the vehicle.

12. A vehicle system, comprising:
a vehicle, having a battery, and having a controller that controls systems of the vehicle, the controller controlling regenerative braking in the vehicle that receives energy from wheels of the vehicle and converts the energy into electricity which is used to charge the battery;
the controller operating to detect the vehicle being in a location which has been previously established as being a location where regenerative braking has made the driving more difficult, the location where regenerative braking has made the driving more difficult at the prior time being previously established at a prior time prior to a current time, and the location where regenerative braking has made the driving more difficult at the prior time being established by at least one other vehicle other than the vehicle; and
the controller modifying the regenerative braking from an unmodified regenerative braking to a modified regenerative braking based on detecting the vehicle being in the location where regenerative braking has made the driving more difficult at the prior time.

13. The system as in claim 12, wherein the controller accesses a database of information to obtain the location where regenerative braking has made the driving more difficult at the prior time.

14. The system as in claim 12, wherein the regenerative braking is automatically resumed to the unmodified regenerative braking after the vehicle is no longer in the location where regenerative braking has made the driving more difficult at the prior time.

15. (canceled)

16. The system as in claim 12, wherein the regenerative braking is modified by reducing an amount of regenerative braking while in the location where regenerative braking has made the driving more difficult at the prior time.

17. A vehicle system, comprising
a vehicle, having
a controller; and
a battery, that is charged by regenerative braking controlled by the controller;
the controller receiving inputs from at least one sensor;
the controller detecting an erratic operation of the vehicle including erratic accelerator and brake motions;
the controller providing a message to a user querying whether the user is having difficulty with parking, responsive to detecting the erratic accelerator and brake motions;
responsive to the user indicating that the user is having difficulty with parking, marking a current location as a location where regenerative braking has made the driving more difficult; and
the controller operating to detect the vehicle being in a location marked as a location where regenerative braking has made the driving more difficult at a prior time, and the controller operating to modify the regenerative braking responsive to detecting the vehicle being in a location where regenerative braking has made the driving more difficult at the prior time.

18. The system as in claim 17, wherein the regenerative braking is automatically resumed to the unmodified regenerative braking after the vehicle is no longer in the location where regenerative braking has made the driving more difficult at the prior time.

19. The system as in claim 17, wherein information about the location where regenerative braking has made the driving more difficult at the prior time is shared with other vehicles other than the vehicle.

20. The system as in claim 17, wherein information about the location where regenerative braking has made the driving more difficult at the prior time is also received from other vehicles other than the vehicle.

21. The system as in claim 12, where the modified regenerative braking is modified by terminating regenerative braking while in the location where regenerative braking has made the driving more difficult at the prior time.

22. The system as in claim 17, wherein the modified regenerative braking is modified by terminating regenerative braking while in the location where regenerative braking has made the driving more difficult at the prior time.

23. The system as in claim 17, wherein the erratic accelerator and brake motions include stop and go creeping operations while driving.
